(19) United States
(12) Patent Application Publication
(10) Pub. No.: US 2002/0091656 A1
(43) Pub. Date: Jul. 11, 2002

(54) System for professional development training and assessment

(76) Inventor: Chet D. Linton, Sandy, UT (US)

Correspondence Address: Kirton & McConkie, 1800 Eagle Gate Tower, 60 East South Temple, Salt Lake City, UT, 84111, US

(21) Appl. No.: 09/945,246

(22) Filed: Aug. 31, 2001

Related U.S. Application Data
(60) Provisional application No. 60/229,206, filed on Aug. 31, 2000.

(51) Int. Cl. G06E 1/00

(52) U.S. Cl. 706/27

(57) ABSTRACT

A web-enabled system for teaching skills to participants, assisting participants in integrating and applying those skills to their vocation, assessing the success of participants in applying the skills, and evaluating whether or not additional training is necessary is disclosed. The present system may be used to train instructors based on federal, state or regional industry standards and to assist them in integrating their training into their work environment. This system operates by initially providing a matrix that automatically conforms to standards set by the state or regional districts where the instructor works. Next, instructors use the matrix to train. The system then enables the instructor to integrate the training into their work environment. After the instructor teaches based on the training received, students of the instructor may then be assessed using any of the standardized examinations. The data from these examinations assesses and analyzes students within the instructor's purview at all levels and at all demographics and may be forwarded to an administrator or supervisor of the instructor and used in the instructor's evaluation, either by a supervisor of the instructor, or simply by the instructor for his or her own self-assessment. If the assessment reveals students of the instructor are deficient in certain areas, this signals the instructor may need more training in those areas. The instructor may then participate in additional development training, which begins the cycle anew.

### RELATED APPLICATIONS

This application claims priority to provisional patent application No. 60/229,206, filed Aug. 31, 2000.

### BACKGROUND

1. Field of Invention

This invention relates to a web-enabled system for teaching skills to participants, assisting participants in integrating and applying those skills to their vocation, assessing the success of participants in applying the skills, and evaluating whether or not additional training is necessary. More particularly, and by way of example only, the present system may be used in an educational setting. The present system may be used to train educational instructors based on federal or state teaching standards and to assist them in integrating their training into lesson plan designs. This system may operate by initially, providing a matrix that automatically conforms to standards set by the state or regional districts where the instructor teaches. Next, the instructors use the matrix to train. The system then enables the instructor to integrate the training into a lesson plan and ultimately, into classroom instruction. After the instructor teaches students based on the training received, students of the instructor may then be assessed using any of the standardized examinations. The data from these examinations assesses and analyzes students at all levels and at all demographics and may be forwarded to an administrator or supervisor of the instructor and used in the instructor's evaluation, either by a supervisor of the instructor, or simply by the instructor for his or her own self-assessment. If the assessment reveals students of the instructor are deficient in certain areas, this signals the instructor may need more training in those areas. The instructor may then participate in additional development training, which begins the cycle anew. The present system may be used for training professionals in areas outside academia, such as for training professionals in sales, safety, or any other area that involves training and assessment as to the assimilation and effectiveness of that training.

2. Background

A majority of industries that require professional development have curriculums and standards outlining the objectives for instructors in those industries. Some industries even base instructors'salaries or continued employment on the evaluation and success of students within the instructors'purview. For instance, in an academic setting, if teachers fail to provide instruction at the level required by the federal, state or regional school required level, and their students demonstrate deficiencies in certain areas, the teachers'job or salary may be affected.

Unfortunately, despite federal, state or regionally mandated standards, there is not only little supervision of instructors to ensure they meet and implement such standards, but also there is little guidance available for instructors as to how to implement those standards.

Furthermore, there are many areas in which to train educators, in particular. For instance, training in leadership, interpersonal skills, discipline, communication skills, or even in the basic subject matters the educator instructs in is often a necessity for an educator to teach and convey lesson plans successfully. However, another drawback with respect to educator improvement results when school districts only focus on a single element for improvement of their instructors, because budgetary restraints preclude focusing on more than one area. This limits school districts in their abilitiy to train or improve in more than one area. As a consequence, though necessity calls for improvement in more than one area, school districts end up choosing one area, among many, for training their teachers even though a broad base of training is necessary.

Yet another drawback with current techniques of professional development occurs when administrators want instructors to focus on one area of professional development, while instructors, school members or the public desires development of instructors in another area. This fragmented approach to training may result in instructors receiving training in areas that instructors oftentimes feel are unnecessary or unproductive. Also, such a fragmented approach in training may not improve the quality of instruction to students, which is the ultimate goal.

Moreover, since many school districts do not correlate student assessment data or provide feedback to instructors based on the assessment data, it is difficult to determine whether or not the training results in any improvement in students'scores.

### BRIEF SUMMARY AND OBJECTS OF THE INVENTION

It is therefore an object of some embodiments of the present invention to provide a training system to assist in the development of professionals in discrete areas of instruction. These areas of instruction may be those mandated by federal or state regulations or simply may be in areas where organizations feel their instructors or trainees need improvement.

Another object of some embodiments of the present invention is to provide a system for professional development where there is supervision of instructors to ensure they meet and implement federal, state or local standards.

Yet another object of some embodiments of the present invention is to provide a system for professional development where there is guidance available for instructors as to how to implement federal, state or local standards.

In order to briefly set forth the summary of the present invention, the implementation of the present invention in an academic environment is provided. The first step in some embodiments of the present invention is to provide development training for instructors within an academic environment, such as a school district. These professionals are trained by accessing, via the internet, audio or video presentations on topics of interest, such as leadership training, math skills, communication skills, English skills, and similar subjects of consequence and important to the professional development of educational instructors. These topics for professional development may also be dictated by federal or state governmental standards or by the school district itself.

Some embodiments of the present invention monitor the participation by the instructor in the training and may provide self-evaluation examinations so that the instructor may determine whether or not the instruction has been integrated. The system provides that once a level of comprehension is attained, the instructor may then move to a matrix or template that assists the instructor in completing and designing instructional lesson plans. These lesson plans integrate the training the instructor just received. The ultimate purpose of the lesson plan matrix is to guide the instructor in creating instructional lesson plans that comply with standards set by the federal and state governments. Also integrated into the lesson plan design and the applied classroom instruction are the skills now learned by the instructor during the development training. Put another way, the professional development concepts and strategies all become part of the pedagogy.

After a period of time elapses, in which these newly trained skills are implemented and utilized, students under the purview of the instructor are given standardized examinations, such as CRT, SAT, or MAT. This assessment data derived from these tests is then analyzed at all levels of comprehension and then correlated with student demographics. This analysis is then provided to the instructor for instructor self-assessment or may be provided to the administrator for instructor review and advancement decisions. If the assessment reveals the training resulted in an improvement in student performance, then the school district or supervisor may provide refresher training, more complex training in that area, or may expand the training into additional areas of training, which are thought to be needed. If the assessment analysis demonstrates in specific areas of training there was no net improvement, then those areas may either be deleted from the training program, replaced with other standards shown to be successful, or more training may be made available.

Additionally, this information may be shared between school districts in a region so that successful concepts may be widely integrated.

These and other objects and features of the present invention will become more fully apparent from the following description, drawing, and the appended claims. Other objects will likewise become apparent from the practice of the invention as set forth hereafter.

### BRIEF DESCRIPTION OF THE DRAWING

In order that the manner in which the above-recited and other advantages and objects of the invention are obtained, a more particular description of the invention briefly described above will be rendered by reference to specific embodiments thereof, which are illustrated in the appended drawing. Understanding that this drawing depicts only typical embodiments of the invention and are therefore not to be considered limiting of its scope, the invention will be described with additional specificity and detail through the use of the accompanying drawing in which:

FIG. 1 is a flow chart showing the various segments of the improvement continuum integrating the system of the present invention.

### DETAILED DESCRIPTION OF THE PREFERRED EMBODIMENTS

It is emphasized that the present invention, as illustrated in the figure and description herein, can be embodied in other forms. Thus, neither the drawing nor the following more detailed description of the various embodiments of the system and method of the present invention limit the scope of the invention. The drawing and detailed description are merely representative of the particular embodiments of the invention; the substantive scope of the present invention is limited only by the appended claims. The various embodiments of the invention will best be understood by reference to the drawing, wherein like elements are designated by like alphanumeric characters throughout.

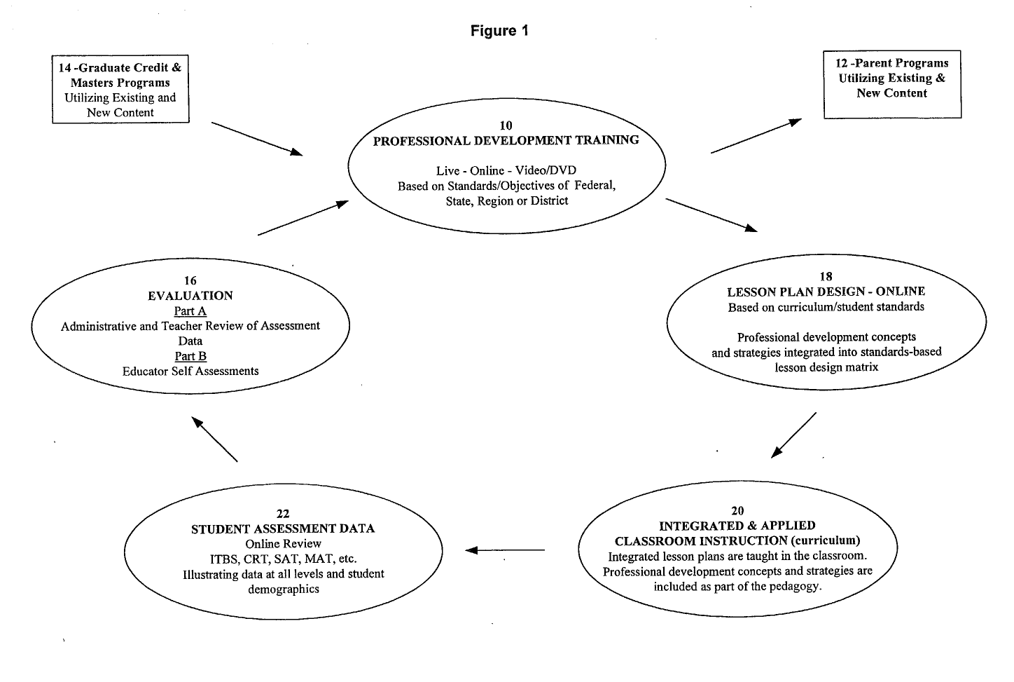

Referring now to FIG. 1, professional development training 10 is provided comprising a combination of live, on-line, and video presentations directed to specific areas of improvement. In an educational context, these areas of improvement may correspond to standards set forth by a school district or a group of parents, such as the Parent Teacher Association. In a broader context, the areas of improvement may be aimed at and correspond with standards set forth by the private entity providing the training, or, if a public entity, by the federal or state government.

As set forth in an academic setting, this professional development training 10 may also be accessed through parent programs 12, in which parents may monitor the training being provided instructors and may offer feedback on areas where parents believe further training is required. The parents may also participate themselves in the programs so that they may support the instructors and supplement the instruction being offered their children.

Further, college students pursuing education degrees, graduates of education, and masters'students preparing to be educational instructors may also go through program 14, where they receive professional development training either for the purpose to improve the likelihood of being hired by a school district, because their training is customized to conform with that particular school districts standards and style, or because the school district also mandate a potential applicant instructor undergo such training before the instructor is considered for the job and hired.

After an instructor proceeds through a unit of professional development training 10, the instructor may take a self-assessment examination to determine whether or not the training has been comprehended and integrated. When the instructor is satisfied with his or her comprehension of the training unit, the instructor then may access an on-line lesson plan development matrix 18 that guides the instructor through the creation of lesson plans. These lesson plans conform with standards applicable to that instructor and to local or national standards.

After creating the lesson plan or plans, the instructor then applies the training from the professional development training unit by integrating the concepts in that unit into the lesson plans. These integrated lesson plans 20 are used by the instructor so that the professional development concepts and strategies are included as part of the pedagogy.

The professional development training 10 units are available on-line, through videotapes or digital versatile discs (DVDs) and may be accessed throughout the school year so that the concepts may be refreshed in the minds of the instructor. At the end of some period of assessment, for example, after a quarter or semester, students are given an assessment examination, such as the ITBS, CRT, SAT, or MAT that creates student assessment data 22. This student assessment data 22 is analyzed to determine whether or not a student's scores have improved from previous assessment base-line data and whether or not that improvement data may be attributed to the training. If there is an improvement in the student assessments that can be attributed to the instructor's training, then that training may be refreshed each year or more difficult or more complex training principles may be introduced the next year. The cycle may continue until there appears to be no added improvement resulting from the additional training. Successful training may also be communicated to other school districts so that they can take advantage of the research of other school districts. Student assessment data may not only be used for the educator's self-assessment, but also may be forwarded for administrative and teacher review 16.

In many parts of the country, so-called “high stakes testing” are used wherein the salary, advancement, or continued employment of an instructor is based on standardized student assessment. Embodiments of the present invention provide evaluation standards to be used by an administrator so that such decisions can be based upon verifiable and quantifiable criteria. The evaluation process may also be used to determine which areas of professional development training needs to be revisited by an instructor or introduced into the system. For example, if math scores are low, and other school districts has experienced success in implementing a communication skills professional development training, which seems to have improved math scores, then the administrator may place that unit into the mandatory curriculum for instructors.

It will be appreciated that the professional development training system set forth above may also be utilized for any private or public entity training, and not just for educational training. For example, the Occupational Safety and Health Administration (OSHA) or similar federally mandated safety training entity may be taught using the embodiments of the present invention herein described. Specifically, instructors or trainees may be trained on-line through video/DVD capabilities of the present invention, and personal assessments may be used to determine whether or not the concepts have been comprehended. A plan may also be developed for incorporating the professional concepts and strategies into the workflow and daily regiment for the professional. Evaluation and assessment data may then be provided an administrator or a supervisor of the trainee/professional to verify that concepts have been successfully integrated.

The present invention may be embodied in other specific forms without departing from its spirit or essential characteristics. The described embodiments are to be considered in all respects only as illustrative, and not restrictive. The scope of the invention is, therefore, indicated by the appended claims rather than by the foregoing description. All changes that come within the meaning and range of equivalency of the claims are to be embraced within their scope.

What is claimed is:

1. A system for professional development, said system comprising the steps of:
providing training that teaches skills;
providing a matrix for said training, wherein said matrix incorporates said skills learned in said training into the workflow and daily activities of a professional undergoing said training;
providing work sheets and guidelines within said matrix for integrating said training into an environment wherein said professional works;
assessing the success of said training in improving the performance of said professional; and
providing evaluations of the success of said training.

2. A system as in claim 1, wherein said step of providing evaluations of the success of said training, further comprises providing evaluations to said supervisor of said professional.

3. A system as in claim 1, wherein said step of providing evaluations of the success of said training, further comprises providing evaluations to said professional for self-assessment.

4. A system as in claim 1, wherein said training is professional development training.

5. A system in claim 1, wherein said training is provided on-line.

6. A system in claim 5, wherein said on-line training comprises audio, video or DVD training.

7. A system for professional development, said system comprising the steps of:
providing on-line professional development training;
providing a matrix for said on-line professional development training, wherein said matrix incorporates skills learned in said professional devleopment training into the workflow and daily activities of a professional undergoing said professional development training;
providing work sheets and guidelines within said matrix for integrating said professional development training into said professional's environment;
assessing the success of said professional development training in improving the performance of said professional; and
providing evaluations of the success of said professional.

8. The system of claim 1, wherein said matrix is based on standards provided by an industry.

9. In a system that includes a computer device, a method for providing professional training and development, the method comprising steps for:
providing information to a user, wherein said information relates to a particular profession;
enabling said user to learn skills and knowledge from said information that can be incorporated into said user's particular profession;
enabling said user to organize an instructional plan relating to said information, wherein said instructional plan is based on said skills and knowledge acquired by said user and;
electronically assessing said user's knowledge of the information.

10. A system as in claim 9, wherein said step of providing information to a user further comprises said user accessing said information on-line.

11. A system as in claim 9, wherein said information is based on standards regulating said particular profession.
